(19) United States
(12) Patent Application Publication
(10) Pub. No.: US 2026/0052605 A1
(43) Pub. Date: Feb. 19, 2026

(54) HEATER ASSEMBLY AND METHOD

(71) Applicant: NICOVENTURES TRADING LIMITED, London (GB)

(72) Inventor: David LEADLEY, London (GB)

(21) Appl. No.: 19/101,933

(22) PCT Filed: Aug. 7, 2023
(86) PCT No.: PCT/GB2023/052081

§ 371 Date: Feb. 7, 2025

(30) Foreign Application Priority Data
Aug. 8, 2022 (GB) 2211519.0

(51) Int. Cl. H05B 3/16; A24F 40/10; A24F 40/42; A24F 40/46; A24F 40/48; A24F 40/70

(52) U.S. Cl. CPC H05B 3/16; A24F 40/10; A24F 40/42; A24F 40/46; A24F 40/48; A24F 40/70; H05B 2203/017; H05B 2203/021

(57) ABSTRACT

A heater assembly for an aerosol provision system, the heater assembly including a substrate; a heater layer configured to generate heat when supplied with energy, the heater layer provided on a first surface of the substrate; and one or more capillary tubes extending from another surface of the substrate through the heater layer provided on the first surface of the substrate. The substrate includes a first portion and a second portion, the first portion including the first surface of the substrate, wherein at least one dimension of the one or more capillary tubes in the first portion of the substrate is different to a corresponding dimension of the one or more capillary tubes in the second portion of the substrate, and wherein the substrate additionally includes a liquid aerosol-generating material storage region located between the first portion and the second portion of the substrate. Also described is a cartomizer including the heater assembly, an aerosol provision system including the heater assembly, and a method for manufacturing the heater assembly.

### RELATED APPLICATIONS

The present application is a National Phase entry of PCT Application No. PCT/GB2023/052081 filed Aug. 7, 2023, which claims priority to GB Application No. 2211519.0 filed Aug. 8, 2022, each of which is hereby incorporated by reference in their entirety.

### FIELD

The present disclosure relates to electronic aerosol provision systems such as nicotine delivery systems (e.g. electronic cigarettes and the like).

### BACKGROUND

Electronic aerosol provision systems such as electronic cigarettes (e-cigarettes) generally contain a reservoir of a source liquid containing a formulation, typically including nicotine, from which an aerosol is generated, e.g. through heat vaporization. An aerosol source for an aerosol provision system may thus comprise a heater having a heating element arranged to receive source liquid from the reservoir, for example through wicking/capillary action. While a user inhales on the device, electrical power is supplied to the heating element to vaporize source liquid in the vicinity of the heating element to generate an aerosol for inhalation by the user. Such devices are usually provided with one or more air inlet holes located away from a mouthpiece end of the system. When a user sucks on a mouthpiece connected to the mouthpiece end of the system, air is drawn in through the inlet holes and past the aerosol source. There is a flow path connecting between the aerosol source and an opening in the mouthpiece so that air drawn past the aerosol source continues along the flow path to the mouthpiece opening, carrying some of the aerosol from the aerosol source with it. The aerosol-carrying air exits the aerosol provision system through the mouthpiece opening for inhalation by the user.

Typically, such aerosol provision systems are provided with heater assemblies suitable for heating the source liquid to form an aerosol. However, conventional heater assemblies do not necessarily provide an efficient liquid supply to the heater element of the heater assembly in various circumstances, particularly when the aerosol provision system is held at a different orientation.

Various approaches are described which seek to help address some of these issues.

### SUMMARY

According to a first aspect of certain embodiments there is provided a heater assembly for an aerosol provision system, the heater assembly including a substrate; a heater layer configured to generate heat when supplied with energy, the heater layer provided on a first surface of the substrate; and one or more capillary tubes extending from another surface of the substrate through the heater layer provided on the first surface of the substrate, wherein the substrate comprises a first portion and a second portion, the first portion comprising the first surface of the substrate, wherein at least one dimension of the one or more capillary tubes in the first portion of the substrate is different to a corresponding dimension of the one or more capillary tubes in the second portion of the substrate, and wherein the substrate additionally comprises a liquid aerosol-generating material storage region located between the first portion and the second portion of the substrate. According to a second aspect of certain embodiments there is provided a cartomizer for use with an aerosol-generating device for generating aerosol from an aerosol-generating material, the cartomizer including a reservoir for storing aerosol-generating material, and a heater assembly according to the first aspect, wherein the heater assembly is provided in fluid communication with the reservoir.

According to a third aspect of certain embodiments there is provided an aerosol provision system for generating aerosol from an aerosol-generating material, the aerosol provision system including the heater assembly of the first aspect.

According to a fourth aspect of certain embodiments there is provided a method of manufacturing a heater assembly for an aerosol provision system, the method including providing a substrate comprising a heater layer configured to generate heat when supplied with energy, the heater layer provided on a first surface of the substrate, wherein the substrate comprises a first portion and a second portion, the first portion comprising the first surface of the substrate; forming one or more capillary tubes extending from another surface of the substrate through the heater layer provided on the first surface of the substrate, wherein at least one dimension of the one or more capillary tubes in the first portion of the substrate is different to a corresponding dimension of the one or more capillary tubes in the second portion of the substrate; and providing a liquid aerosol-generating material storage region located between the first portion and the second portion of the substrate.

According to a fifth aspect of certain embodiments there is provided a heater means for an aerosol provision system, the heater means including a substrate; heater layer means configured to generate heat when supplied with energy, the heater layer means provided on a first surface of the substrate; and capillary means extending from another surface of the substrate through the heater layer provided on the first surface of the substrate, wherein the substrate comprises a first portion and a second portion, the first portion comprising the first surface of the substrate, wherein at least one dimension of the capillary means in the first portion of the substrate is different to a corresponding dimension of the capillary means in the second portion of the substrate, wherein the substrate additionally comprises a liquid aerosol-generating material storage means located between the first portion and the second portion of the substrate.

It will be appreciated that features and aspects of the invention described above in relation to the first and other aspects of the invention are equally applicable to, and may be combined with, embodiments of the invention according to other aspects of the invention as appropriate, and not just in the specific combinations described above.

### BRIEF DESCRIPTION OF THE DRAWINGS

Embodiments of the invention will now be described, by way of example only, with reference to the accompanying drawings, in which:

FIG. 1 is a perspective view of an aerosol provision system in accordance with aspects of the present disclosure;

FIG. 2 is an exploded perspective view of a cartomizer suitable for use in the aerosol provision system of FIG. 1;

FIG. 3 is a perspective view of a heater assembly in accordance with aspects of the present disclosure, wherein the heater assembly comprises a substrate comprising first and second portions and a having a liquid aerosol-generating material storage region located between the first and second portions, an electrically resistive layer, and capillary tubes extending through the substrate and electrically resistive layer;

FIGS. 4a and 4b are cross-sectional views of the heater assembly of FIG. 3 showing capillary tubes comprising different dimensions; FIG. 4a shows capillary tubes comprising different diameters in first and second portions of a substrate according to a first implementation, while FIG. 4b shows capillary tubes comprising different lengths in first and second portions of a substrate according to a second implementation;

FIG. 5 is a cross-sectional view of an alternative configuration of the heater assembly of FIG. 3, whereby the substrate of the heater assembly comprises a cavity as a liquid aerosol-generating material storage area; and

FIG. 6 is a method in accordance with aspects of the present disclosure for forming a heater assembly.

### DETAILED DESCRIPTION

Aspects and features of certain examples and embodiments are discussed/described herein. Some aspects and features of certain examples and embodiments may be implemented conventionally and these are not discussed/described in detail in the interests of brevity. It will thus be appreciated that aspects and features of apparatus and methods discussed herein which are not described in detail may be implemented in accordance with any conventional techniques for implementing such aspects and features.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the non-combustible aerosol provision system is an electronic cigarette, also known as a vaping device, electronic cigarette or electronic nicotine delivery system (END), although it is noted that the presence of nicotine in the aerosol-generating material is not a requirement. Throughout the following description the term “e-cigarette” is sometimes used but this term may be used interchangeably with aerosol (vapor) provision system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

In some embodiments, the or each aerosol-generating material may comprise one or more active constituents, one or more flavors, one or more aerosol-former materials, and/or one or more other functional materials.

The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical.

In some embodiments, the active substance comprises nicotine. In some embodiments, the active substance comprises caffeine, melatonin or vitamin B12.

As noted herein, the active substance may comprise or be derived from one or more botanicals or constituents, derivatives or extracts thereof. As used herein, the term “botanical” includes any material derived from plants including, but not limited to, extracts, leaves, bark, fibers, stems, roots, seeds, flowers, fruits, pollen, husk, shells or the like. Alternatively, the material may comprise an active compound naturally existing in a botanical, obtained synthetically. The material may be in the form of liquid, gas, solid, powder, dust, crushed particles, granules, pellets, shreds, strips, sheets, or the like. Example botanicals are tobacco, eucalyptus, star anise, hemp, cocoa, cannabis, fennel, lemongrass, peppermint, spearmint, rooibos, chamomile, flax, ginger, ginkgo biloba, hazel, hibiscus, laurel, licorice (liquorice), matcha, mate, orange skin, papaya, rose, sage, tea such as green tea or black tea, thyme, clove, cinnamon, coffee, aniseed (anise), basil, bay leaves, cardamom, coriander, cumin, nutmeg, oregano, paprika, rosemary, saffron, lavender, lemon peel, mint, juniper, elderflower, vanilla, wintergreen, beefsteak plant, curcuma, turmeric, sandalwood, cilantro, bergamot, orange blossom, myrtle, cassis, valerian, pimento, mace, damien, marjoram, olive, lemon balm, lemon basil, chive, carvi, verbena, tarragon, geranium, mulberry, ginseng, theanine, theacrine, maca, ashwagandha, damiana, guarana, chlorophyll, baobab or any combination thereof. The mint may be chosen from the following mint varieties: Mentha Arventis, Mentha c.v., Mentha niliaca, Mentha piperita, Mentha piperita citrata c.v., Mentha piperita c. v, Mentha spicata crispa, Mentha cardifolia, Memtha longifolia, Mentha suaveolens variegata, Mentha pulegium, Mentha spicata c.v. and Mentha suaveolens I

n some embodiments, the active substance comprises or is derived from one or more botanicals or constituents, derivatives or extracts thereof and the botanical is tobacco.

In some embodiments, the active substance comprises or derived from one or more botanicals or constituents, derivatives or extracts thereof and the botanical is selected from eucalyptus, star anise, cocoa and hemp.

In some embodiments, the active substance comprises or derived from one or more botanicals or constituents, derivatives or extracts thereof and the botanical is selected from rooibos and fennel. As used herein, the terms “flavor” and “flavorant” refer to materials which, where local regulations permit, may be used to create a desired taste, aroma or other somatosensorial sensation in a product for adult consumers. They may include naturally occurring flavor materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavor enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form.

In some embodiments, the flavor comprises menthol, spearmint and/or peppermint. In some embodiments, the flavor comprises flavor components of cucumber, blueberry, citrus fruits and/or redberry. In some embodiments, the flavor comprises eugenol. In some embodiments, the flavor comprises flavor components extracted from tobacco. In some embodiments, the flavor comprises flavor components extracted from cannabis.

In some embodiments, the flavor may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucolyptol, WS-3.

The aerosol-former material may comprise one or more constituents capable of forming an aerosol. In some embodiments, the aerosol-former material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more other functional materials may comprise one or more of pH regulators, coloring agents, preservatives, binders, fillers, stabilizers, and/or antioxidants.

An aerosol-modifying agent is a substance, typically located downstream of the aerosol generation area, that is configured to modify the aerosol generated, for example by changing the taste, flavor, acidity or another characteristic of the aerosol. The aerosol-modifying agent may be provided in an aerosol-modifying agent release component, that is operable to selectively release the aerosol-modifying agent.

The aerosol-modifying agent may, for example, be an additive or a sorbent. The aerosol-modifying agent may, for example, comprise one or more of a flavorant, a colorant, water, and a carbon adsorbent. The aerosol-modifying agent may, for example, be a solid, a liquid, or a gel. The aerosol-modifying agent may be in powder, thread or granule form. The aerosol-modifying agent may be free from filtration material.

Typically, the non-combustible aerosol provision system may comprise a non-combustible aerosol provision device and a consumable for use with the non-combustible aerosol provision device. In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a mouthpiece, and/or an aerosol-modifying agent.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol.

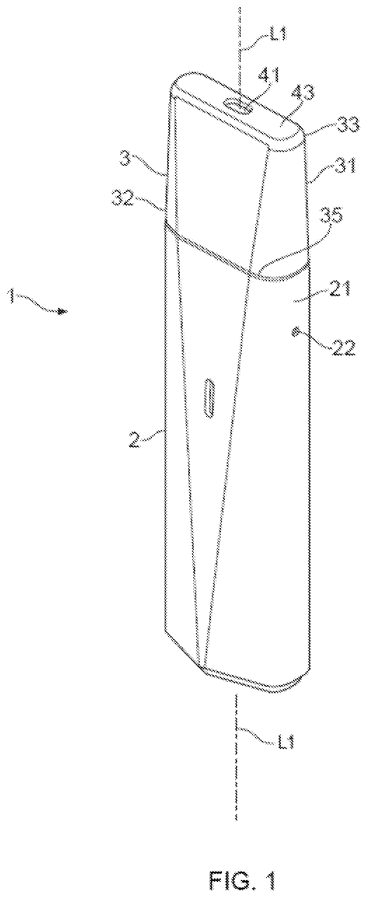

FIG. 1 shows an aerosol provision system 1 comprising an aerosol provision device 2 and a consumable 3, herein shown and referred to as a cartomizer 3. The cartomizer 3 is configured to engage and disengage with the aerosol provision device 2. That is, the cartomizer 3 is releasably connected/connectable to the aerosol provision device 2. More specifically, the cartomizer 3 is configured to engage/disengage with the aerosol provision device 2 along the longitudinal axis L1. The cartomizer 3 and aerosol provision device 2 are provided with suitable interfaces to allow the cartomizer 3 and aerosol provision device 2 to engage/disengage from one another, e.g., a push fit interface, a screwthread interface, etc.

The cartomizer 3 comprises a reservoir which stores an aerosol-generating material. In the following, the aerosol-generating material is a liquid aerosol-generating material. The liquid aerosol-generating material (herein sometimes referred to as liquid) may be a conventional e-liquid which may or may not contain nicotine. However, other liquids and/or aerosol generating materials may be used in accordance with the principles of the present disclosure. The cartomizer 3 is able to be removed from the aerosol provision device 2 when, for example, the cartomizer 3 requires refilling with liquid or replacement with another (full) cartomizer 3.

The aerosol provision device 2 comprises a power source (such as a rechargeable battery) and control electronics. As will be described below, the cartomizer 3 comprises an electrically powered heater assembly. When the cartomizer 3 is coupled to the aerosol provision device 2, the control electronics is configured to supply electrical power to the heater assembly of the cartomizer 3 to cause the heater assembly to generate an aerosol from the liquid aerosol-generating material. The control electronics may be provided with various components to facilitate/control the supply of power to the cartomizer 3. For example, the control electronics may be provided with an airflow sensor configured to detect when a user of the aerosol provision system 1 inhales on the aerosol provision system and to supply power in response to such a detection and/or a push button which is pressed by the user and to supply power in response to such a detection. However, it should be understood that additional functions may be controlled by the control electronics depending on the configuration of the aerosol provision device 2 (for example, the control electronics may be configured to control/regulate recharging of the power source, or to facilitate wireless communication with another electronic device, such as a smartphone). The features and functions of the aerosol provision device 2 are not of primary significance in respect of the present disclosure.

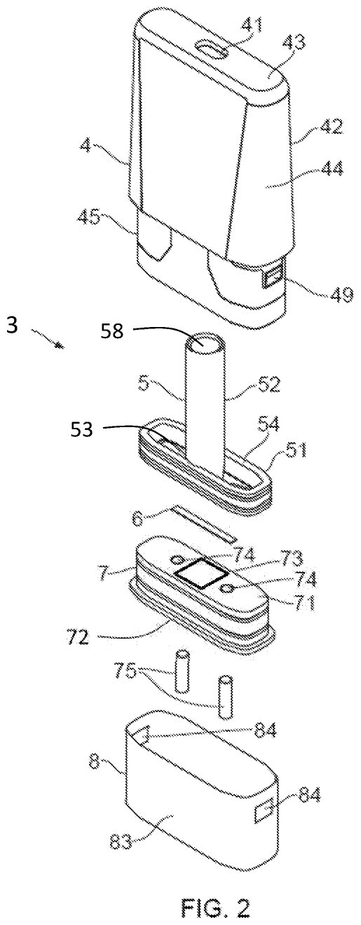

FIG. 2 shows an example cartomizer 3 suitable for use in the aerosol provision system of FIG. 1. From the exploded view of FIG. 2, it may be seen that the cartomizer 3 is assembled from a stack of components: an outer housing 4, an upper clamping unit 5, a heater assembly 6, a lower support unit 7 and an end cap 8.

The cartomizer 3 has a top end 31 and a bottom end 32 which are spaced apart along the longitudinal axis L1, which is the longitudinal axis of the cartomizer as well as being the longitudinal axis of the aerosol provision system 1. The top end 31 of the cartomizer defines a mouthpiece end of the aerosol provision system 1 (on which a user may place their mouth and inhale), and the mouthpiece 33 includes a mouthpiece orifice 41 which is provided at the top end 42 of outer housing 4 in the center of a top face 43.

The outer housing 4 includes a circumferential side wall 44 which leads down from the top end 42 to a bottom end 45 of the outer housing 4 and which defines an internal reservoir 46 for holding the liquid aerosol-generating material. Prior to assembly of the cartomizer 3, the bottom end 45 of the outer housing is open, but upon assembly the bottom end 45 is closed by a plug formed by the upper clamping unit 5 and the lower support unit 7 which are stacked together with the heater assembly 6 sandwiched therebetween.

The upper clamping unit 5 is an intermediate component of the stack of components. The upper clamping unit 5 includes a foot 51 in the form of a block and an upwardly extending air tube 52. On each side of the air tube 52, the foot 51 includes a well 53 which descends from a flat top surface 54 to a flat bottom surface (not shown in FIG. 2) of the foot 51. At the bottom surface, each well 53 is open and, specifically, opens into an elongate recess formed in the bottom surface, with the depth of the recess broadly matching the size/shape and thickness of the heater assembly 6. The foot 51 is designed to engage with the outer housing 4 (more specifically, such that the outer circumferential surface of the foot is pressed against an inner circumferential surface of the outer housing 4). The foot 51 may have a suitable shape and include suitable sealing components to reduce or prevent liquid from leaking between the outer surface of the foot 51 and the inner surface of the housing 4.

The air tube 52 extends up from the bottom of the wells 53 and defines an internal air passage 58. When the upper clamping unit 5 is engaged with the outer housing 4, the air tube 52 extends up to and encircles the mouthpiece orifice 41. The outer housing 4 and/or the air tube 52 may be suitably configured so as to provide a liquid- (and optionally air-) tight seal between the two. As will be understood below, air/aerosol is intended to pass along the air tube 52 and out of the mouthpiece orifice 41, while the space around the air tube 52 and within the outer housing 4 defines the reservoir 46 for storing the liquid aerosol-generating material. Hence, it should be understood that, with the exception of the openings of the wells 53, the reservoir 46 is a sealed volume defined by the outer housing 4, the outer surface of the air tube 52, and the foot 51.

The lower support unit 7 is in the form of a block having a broadly flat top surface 71 and a flat bottom surface 72. A central air passage 73 extends upwardly from the bottom surface 72 to the top surface 71. On each side of the air passage 73, the block of the lower support unit 7 includes a through hole 74. In the example cartomizer 3 of FIG. 2, a co-moulded contact pad 75 in the form of a pin is inserted into the through holes 74. More specifically, each contact pad 75 is press fit in its respective through hole 74. Each contact pad 75 provides an electrical connection path from the bottom surface 72 to a respective end portion of the heater assembly 6 when the heater assembly 6 is sandwiched between the top surface 71 of the lower support unit 7 and the recess of the bottom surface 55 of the upper clamping unit 5.

Much like the upper clamping unit 5, the lower support unit 7 is designed to engage with the outer housing 4 (more specifically, such that the outer circumferential surface of the lower support unit 7 is pressed against an inner circumferential surface of the outer housing 4). The lower support unit 7 may have a suitable shape and include suitable sealing components to reduce or prevent liquid from leaking between the outer surface of the lower support unit 7 and the inner surface of the housing 4. The foot 51 of the upper clamping unit 5 and the lower support unit 7 (with its block-like form) combine together to form a plug which seals the bottom end of the reservoir 46. As shown in FIG. 2, the cartomizer 3 includes an end cap 8 at its bottom end. The end cap 8 is made of metal and serves to assist with retaining the cartomizer 3 in the aerosol provision device 2 when the cartomizer 3 is plugged in to the top end of the aerosol provision device 2, because, in this example, the aerosol provision device 2 is provided with magnets which are attracted to the metal of the end cap 8. The end cap 8 has a bottom wall 81 with a central opening (not shown in FIG. 2). The end cap 8 also has a circumferential side wall 83 which has two opposed cut-outs 84 which latch onto corresponding projections 49 on the outer surface of the bottom end of the side wall 44 of the outer housing 4, so that the end cap 8 has a snap-fit type connection onto the bottom end of the outer housing 4. When the end cap 8 has been fitted in position, it holds in position the lower support unit 7, the upper clamping unit 5 and the heater assembly 6 which is sandwiched between the lower support unit 7 and the upper clamping unit 5.

It would be possible to omit the end cap 8 (in order to reduce the component count) by arranging for the lower support unit 7 to form a snap-fit type connection with the bottom end of the side wall 44 of the outer housing 4. Additionally, the cartomizer 3 could be provided with indentations which engage with projections at the top end 21 of the main housing 2, so that a releasable connection is provided between the cartomizer and the main housing.

In any case, the cartomizer 3 is provided what may more generally be referred to as a device interface which is a part of the cartomizer 3 that interfaces with the main housing 2 (or aerosol-generating device). In the above example, the device interface may include the metal cap 8 including the bottom wall 81 and circumferential side wall 83 and/or the lower support unit 7 including the bottom surface 72. More generally, the device interface of the cartomizer 3 may encompass any part or parts of the cartomizer 3 that contact, abut, engage or otherwise couple to the main housing 2.

When the components of the cartomizer 3 have been assembled together, an overall air passage exists from the bottom end 32 to the top end 31 of the cartomizer 3 and it is formed by the air passage 73 leading to the air passage 58 which, in turn, leads to the mouthpiece orifice 41. Where the air passage 73 meets the air passage 58, the air flow bifurcates as it passes around the side edges of the heater assembly 6.

With reference back to FIG. 1, the top end 21 of the aerosol provision device 2 includes an air inlet hole 22 on each side of the aerosol provision device 2 (with one of the two air inlet holes 22 being visible in FIG. 1). Air can enter the air inlet holes 22 and flow transversely inwards to the longitudinal axis L1 so as to enter the bottom end of the air passage 73 of the lower support unit 7 and to start to flow in the direction of the longitudinal axis L1 towards the mouthpiece 33.

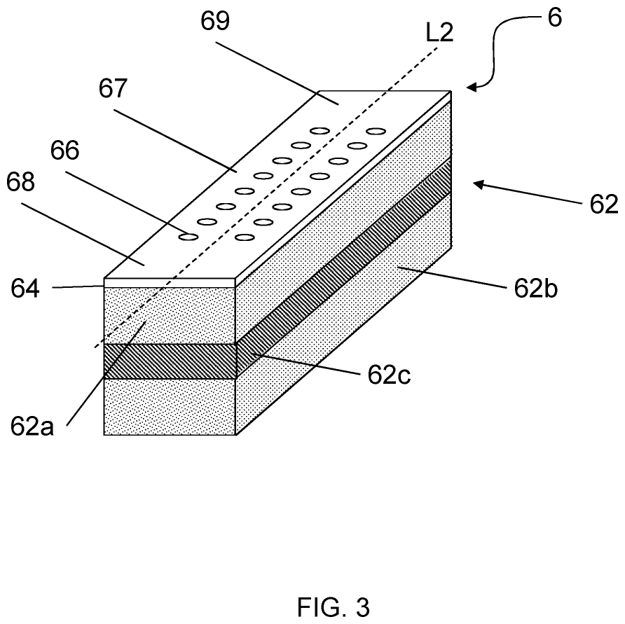

Turning now to the heater assembly 6, the heater assembly 6 is a microfluidic heater assembly. FIG. 3 illustrates the microfluidic heater assembly 6 in more detail.

The microfluidic heater assembly 6 comprises a substrate 62 and an electrically resistive layer 64 disposed on a surface of the substrate 62.

In this implementation, the substrate 62 is formed from a non-conductive material, such as quartz (silicon dioxide); however, it should be appreciated that other suitable non-conductive materials may be used, such as ceramics, for example. The electrically resistive layer 64 is formed from any suitable electrically conductive material, for example a metal or a metal alloy such as titanium or nickel chromium.

The heater assembly 6 is planar and in the form of a cuboidal block, elongate in the direction of a longitudinal axis L2. The heater assembly 6 has the shape of a strip and has parallel sides. The planar heater assembly 6 has parallel upper and lower major (planar) surfaces and parallel side surfaces and parallel end surfaces. In the shown implementation of FIG. 3, the length of the heater assembly 6 is 10 mm, its width is 1 mm, and its thickness is 0.24 mm where the thickness of each of the first portion 62a and second portion 62b is approximately 0.12 mm, and the thickness of the liquid aerosol-generating material storage portion 62c is approximately 0.02 mm). The small size of the heater assembly 6 enables the overall size of the cartomizer to be reduced and the overall mass of the components of the cartomizer to be reduced. However, it should be appreciated that in other implementations, the heater assembly 6 may have different dimensions and/or shapes depending upon the application at hand. For example, in some implementations, the heater assembly 6 may be a 3×3 mm chip.

Along the longitudinal axis L2, the heater assembly 6 has a central portion 67 and first and second end portions 68, 69. In FIG. 3, the length of the central portion 67 (relative to the lengths of the end portions 68, 69) has been exaggerated for reasons of visual clarity. When the vaporizer is in situ in the cartomizer, the central portion 67 is positioned in the air passage 73. The central portion 67 extends across the top end of the air passage 73 of the lower support unit 7, and across the bottom end of the air passage 58 of the upper clamping unit 5. The end portions 68, 69 are clamped between the upper clamping unit 5 and the lower support unit 4.

In the central portion 67 of the heater assembly 6, a plurality of capillary tubes 66 are provided. Only the openings of the capillary tubes 66 are shown in FIG. 3 (and in an exaggerated way for clarity), but the capillary tubes 66 extend from one side of the heater assembly 6 to the other. More specifically, the capillary tubes extend from the side of the heater assembly 6 opposite the electrically resistive layer 64 (the largest surface not shown in FIG. 3), through the substrate 62 toward the face of the substrate 62 on which the electrically resistive layer 64 is disposed, and then through the electrically resistive layer 64. The plurality of capillary tubes 66 extend substantially linearly through the heater assembly 6 (that is, the capillary tubes 66 follow substantially linear paths). By substantially, it is meant that the capillary tubes 66 follow pathways that are within 5 %, within 2 % or within 1 % of a straight line. This measure may be obtained in any suitable way, e.g., by comparison of the length of the distance from a first point to a second point along the extent of the capillary tube 66 and the corresponding distance that the central axis of the capillary tube 66 extends between the same two points. The capillary tubes 66 are formed in the heater assembly 66 via a manufacturing process. That is to say, the capillary tubes 66 do not naturally exist in the substrate material 62 or electrically resistive layer 64, but rather, the capillary tubes 66 are formed in the substrate material 62 and electrically resistive layer 64 through a suitable process. A suitable process for forming the capillary tubes 66, particularly when forming capillary tubes that substantially follow a linear path, is laser drilling. However, any other suitable technique may be employed in order to generate the capillary tubes 66.

The capillary tubes 66 are configured so as to transport liquid from one surface of the heater assembly 6 (i.e., the surface opposite the electrically resistive layer 64) to the electrically resistive layer 64. The exact dimensions of the capillary tubes 66, and in particular the diameter, may be set in accordance with the liquid to be stored in the reservoir 46 of the cartomizer 3 and subsequently used with the heater assembly 6. For example, the properties of the liquid aerosol-generating material (e.g., viscosity) in the reservoir 46 of the cartomizer 3 may dictate the diameter of the capillary tubes 66 to ensure that a suitable flow of liquid is provided to the electrically resistive layer 64. However, in some implementations, the capillary tubes 66 may have a diameter on the order to tens of microns, e.g., between 10 μm to 250 μm, between 10 μm to 150 μm, or between 10 μm to 100 μm. However, it should be appreciated that capillary tubes 66 in other implementations may be set differently based on the properties of the liquid to be vaporized and/or a desired supply of liquid to the electrically resistive layer 64. Moreover, it should be appreciated that to achieve a desired level of flow to the electrically resistive layer 64, not only the diameter of the capillary tubes 66 but also the number/number per unit area of the capillary tubes 66 may also influence the supply of liquid to the electrically resistive layer 64.

In accordance with the principles of the present disclosure, the substrate 62 comprises at least two portions. In FIG. 3, a first portion 62a and a second portion 62b are shown. The first portion 62a comprises, on a surface thereof, the electrically resistive layer 64. The second portion 62b is arranged to be below the first substrate 62a, as seen in FIG. 3. Note that the use of “below” here is not meant to signify any particular orientation of the heater assembly 6 in use, but rather to refer to the directions and orientations of the heater assembly 6 as shown in the orientation of FIG. 3 for ease of description. The second portion 62b therefore comprises the surface of the heater assembly 6 opposite the electrically resistive layer 64. The first and second portions 62a, 62b of the substrate 62 are provided with the capillary tubes 66 described above.

The first and second portions 62a, 62b of the substrate 62 may be formed form the same or different materials. For example, in some implementations, the first and second portions 62a, 62b may be formed from the same material, such as quartz. Providing a first and second portion 62a, 62b from different materials may enable the heater assembly 6 to exhibit different properties/characteristics. For example, the first portion 62a may be formed from a material having superior heat resistance compared to the second portion 62b.

Between the first and second portions 62a, 62b is provided a liquid aerosol-generating material storage region 62c. In the implementation of FIG. 3, the liquid aerosol-generating material storage region 62c comprises an absorbent material. The absorbent material may be formed as a layer of absorbent material which is located (e.g., sandwiched) between the first portion 62a and second portion 62b of the substrate 62. The absorbent material may be attached or adhered to the first and second portions 62a, 62b in any suitable manner, for example using welding or an adhesive. As noted above, the capillary tubes 66 pass through the substrate 62 and consequently the capillary tubes 66 pass through the first and second portions 62a, 62b of the substrate 62. Regions of the first and second portions 62a, 62b which do not comprise capillary tubes 66 may be suitable locations for bonding to the absorbent material. In addition, the capillary tubes 66 formed in the first and second portions 62a, 62b of the substrate 62 may or may not extend through the absorbent material. In some implementations, the capillary tubes 66 do extend through the absorbent material. That is, capillary tubes 66 are formed in the absorbent material which are different (e.g., different in size or shape) to any other porous structures formed in the absorbent material. In some implementations, the capillary tubes 66 may be formed in the heater assembly 6 when the first portion 62a, absorbent material 62c, and second portion 62b are assembled-e.g., via a laser drilling process. In other implementations, the capillary tubes 66 do not extend through the absorbent material. That is, the first portion 62a of the substrate 62 and second portion 62b of the substrate 62 each comprise respective portions of a capillary tube 66 which is interrupted by the absorbent material. As will be discussed below, the absorbent material may act to transport liquid to the capillary tubes 66 (or parts thereof) located in the first portion 62a of the substrate 62.

The absorbent material may comprise any suitable absorbent material which is suitable for absorbing and holding the liquid aerosol-generating material provided in the reservoir 46. The specific properties of the absorbent material may therefore depend upon the specific properties, such as the viscosity, of the liquid aerosol-generating material held in the reservoir 46, and may vary from implementation to implementation. However, some examples of generally suitable materials include fibrous cotton, sponges, ceramics, or sintered materials such as sintered quartz. The absorbent material is provided with suitable porosity/pore size/channel size for the properties of the liquid stored in the reservoir 46. In this regard, the dimensions of the pore size (or average pore size) or channel size of the absorbent material may be selected to be in the range of 1 μm to 250 μm, between 1 μm to 150 μm, or between 1 μm to 100 μm in order to provide suitable absorption for conventional e-liquids, although it should be appreciated that the exact (average) size may be different in different implementations.

The structure and associated features of the heater assembly 6 of FIG. 3 will be discussed in more detail below. With reference back to FIG. 2, the heater assembly 6 is shown positioned between the upper clamping unit 5 and the lower support unit 7. In particular, the heater assembly 6 is oriented such that the electrically resistive layer 64 faces towards the lower support unit 7, while the substrate 62 (and in particular the second portion 62b thereof) faces towards the upper clamping unit 5.

It should be understood from FIG. 2 that the end portions 68, 69 of the heater assembly 6 overlap the through holes 74 and the contact pads 75. More specifically, the electrically resistive layer 64 is provided in contact with the contact pads 75, and therefore the end portions 68, 69 act to form an electrical connection with the contact pads 75 (and thus any power source subsequently attached to the contact pads 75, such as from the aerosol provision device 2). For example, the aerosol provision device 2 may have two power supply pins (not shown) which make contact with the bottom ends of the contact pads 75. The top ends of the contact pads 75 are in electrical contact with the heater assembly 6, as above. In use, electrical power supplied by the power supply of the aerosol provision device 2 passes through the electrically resistive layer 64, by virtue of the electrical connection between the end portions 68, 69 and the contact pads 75, to cause heating of the electrically resistive layer 64. The amount of heating achieved (i.e., the temperature of the electrically resistive layer 64 that is able to be reached) may depend on the power supplied by the aerosol provision device 2 and the electrical resistance of the electrically resistive layer 64. Equally, the amount of heating required (i.e., the temperature necessary to vaporize the liquid supplied to the resistive layer 64) will be dependent in part on the properties of the liquid supplied to the electrically resistive layer 64. Accordingly, the resistance of the electrically resistive layer 64 may be set based on the particular application at hand, whereby the resistance of the electrically resistive layer 64 may be dependent on the material of the electrically resistive layer 64 and the physical dimensions of the electrically resistive layer 64 (e.g., thickness). By way of example, the thickness of the electrically resistive layer 64 may be on the order of 5 μm or so, but it will be appreciated that this may vary from implementation to implementation.

The substrate 62 is configured to receive liquid from the reservoir 46 from above. More specifically, regions of the second portion 62b of the substrate 62 (which may broadly correspond to respective ends of the central portion 67 of the substrate 62) are positioned in fluid communication with the wells 53 and hence the liquid aerosol-generating material stored in the reservoir 46 of the cartomizer 3. Capillary tubes 66 provided in these regions of second portion 62b of the substrate 62 initially receive, e.g., via capillary action, the liquid aerosol-generating material from the reservoir 46 via the wells 53. Liquid is transported along the capillary tubes 66 (i.e., in the longitudinal direction of extent of the capillary tubes 66) of the second portion 62b to the liquid aerosol-generating material storage region 62c. That is, the capillary tubes 66 of the second portion 62b are in fluid communication with the liquid aerosol-generating material storage region 62c. The liquid aerosol-generating material storage region 62c subsequently absorbs and stores/holds the liquid aerosol-generating material. It should be appreciated that by virtue of the presence of the liquid aerosol-generating material storage region 62c, the heater assembly 6 is capable of retaining a greater volume of liquid than would otherwise be possible if the liquid-aerosol generating material storage region 62c were not present (i.e., in the capillary tubes 66 alone). Liquid that is held in the liquid aerosol-generating material storage region 62c is subsequently able to be passed to the capillary tubes 66 located in the first portion 62a of the substrate 62, e.g., via capillary action. That is, the capillary tubes 66 of the first portion 62a are in fluid communication with the liquid aerosol-generating material storage region 62c. As described above, as liquid in the capillary tubes 66 of the first portion 62a approach the electrically resistive layer 64, and assuming said layer 64 is energized via a suitable electrical current applied thereto, the liquid aerosol-generating material is vaporized and forms a vapor/aerosol at or around the surface of the electrically resistive layer 64.

The liquid aerosol-generating material storage region 62c of the substrate 62 provides several features to the heater assembly 6.

Firstly, as described above, the liquid aerosol-generating material storage region 62c provides a region within the substrate 62/heater assembly 6 for storing an amount of liquid aerosol-generating material. The stored liquid aerosol-generating material can be supplied to the capillary tubes 66 of the first portion 62a even when the liquid supply to the liquid aerosol-generating material storage region 62c is stopped or temporarily stopped. For example, FIG. 2 shows the heater assembly 6 with the second portion 62b of the substrate 62 facing towards the reservoir 46 and the first portion 62a of the substrate 62 facing away from the reservoir 46. When the cartomizer 3 is held with the mouthpiece 33 facing upward with respect to FIG. 1 or 2 (i.e., the longitudinal axis L1 of the cartomizer 3/device 2 is approximately parallel with the direction of gravity with the mouthpiece 33 facing in the opposite direction to the direction of gravity), liquid is supplied from the reservoir 46 to the second portion 62b of the substrate 62. However, when the cartomizer 3/device 2 is inverted such that the heater assembly 6 is orientated in the opposite direction where the cartomizer 3 is held with the mouthpiece 33 facing downwards with respect to FIG. 1 or 2 (i.e., the longitudinal axis L1 of the cartomizer 3/device 2 is approximately parallel with the direction of gravity with the mouthpiece 33 facing in the direction to the direction of gravity), the second portion 62b is no longer being fed by liquid from the reservoir 46 via the wells 53. Accordingly, liquid is not being fed to the liquid aerosol-generating material storage region 62c in such a scenario. However, because the liquid aerosol-generating material storage region 62c stores/holds an amount of liquid, even when the cartomizer 3 is inverted, liquid is still able to be supplied to the first portion 62a of the substrate 62 and to the electrically resistive layer 64. Of course, when the liquid aerosol-generating material storage region 62c runs out of liquid, liquid can no longer be supplied to the electrically resistive layer 64 all the time the cartomizer 3 remains inverted (or at least, with the second portion 62b not receiving liquid from the reservoir 46). The liquid aerosol-generating material storage region 62c may therefore be suitably configured according to the expected length of time that the cartomizer 3 may remain inverted (or the second portion 62b out of fluid contact with the liquid in the reservoir 46). For example, during normal use, one might expect the system 1 to be held horizontal (i.e. the longitudinal axis L1 at approximately 90° with respect to the direction of gravity) while a user inhales on the aerosol provision system 1 for a period of approximately five seconds or so. The storage volume of the liquid aerosol-generating material storage region 62c may be suitably set to account for this time period, for example. For example, this may be set to a volume corresponding to a single puff or multiple puffs (e.g., which may define a session of 5, 10 or 20 puffs). For a given puff, the amount of liquid vaporized may depend on a number of parameters and thus vary accordingly (and may be determined empirically or through computer simulation), but typically the volume per puff is on the order of approximately 2 to 10 μl. Therefore, the volume of the liquid aerosol-generating material storage region 62c may be greater than or equal to 2 μl, for example, between 2 to 200 μl.

Secondly, the liquid aerosol-generating material storage region 62c also allows for the lateral/horizontal movement of liquid within the heater assembly 6. As noted above, the configuration of the cartomizer 3 shown in FIG. 3 is one where the vaporization of liquid occurs in a certain region of the heater assembly 6; namely, the center portion 67 of the heater assembly 6. Owing to the arrangement of the heater assembly 6 with respect to the wells 53 and the central air passage 73/58, only certain regions of the heater assembly 6 may be in contact with the wells 53. For example, potentially only the regions at either end of the central portion 67 may be in contact with the wells 53. In alternative implementations, the end portions 68, 69 of the heater assembly 6 may be in contact with the wells 53 (and subsequently have capillary tubes 66 at least in the second portion 62b of the heater assembly 6 to allow for liquid to flow to the liquid aerosol-generating material storage region 62c). In either implementation, the liquid within the liquid aerosol-generating material storage region 62c may be permitted to flow along the length of the liquid aerosol-generating material storage region 62c (e.g., broadly in the direction along the longitudinal axis L2), and consequently be capable of passing through any of the capillary tubes 66 in the central portion 67 to the electrically resistive layer 64. This may help facilitate a more efficient and uniform aerosolization of the liquid aerosol-generating material. Hence, in summary, the liquid aerosol-generating material storage region 62c is provided to aid with at least one of: providing consistent aerosolization/vaporization even in the event that the cartomizer 3 is inverted or the second portion 62b of the heater assembly 6 is brought out of direct contact with the liquid in the reservoir 46; and providing a more consistent and efficient vaporization by allowing liquid to permeate through the majority of the heater assembly 6 and to the electrically resistive layer 64. The heater assembly 6 can be suitably configured to aid the supply of liquid to the electrically resistive layer 64 of the heater assembly 6. Not only can the capillary tubes 66 be configured to have a suitable dimension (e.g., diameter) for a given liquid aerosol-generating material, but by virtue of the fact that the substrate 62 comprises a first portion 62a and a second portion 62b, the capillary tubes 66 can be configured differently in each of the respective portions 62a, 62b. In particular, at least one dimension of the one or more capillary tubes 66 in the first portion 62a of the substrate is different to a corresponding dimension of the one or more capillary tubes 66 in the second portion 62b of the substrate 62.

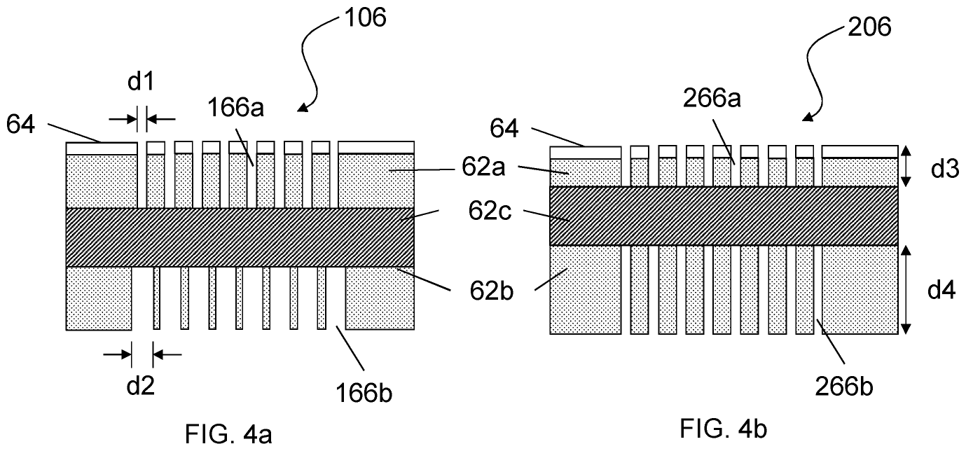

FIGS. 4a and 4b each schematically show a cross-sectional view of different implementations of heater assemblies 106, 206 having capillary tubes 166, 266 with a configured differently in the respective portions 62a, 62b of the substrate 62.

Turning to FIG. 4a first, FIG. 4a shows a first implementation of the heater assembly 106. Heater assembly 106 is broadly similar to heater assembly 6 described in FIG. 3, and in this regard the heater assembly 106 comprises a substrate 62 having a first portion 62a, second portion 62b and a liquid aerosol-generating material storage region 62c as described above, as well as an electrically resistive layer 64 again as described above. A description of these components is not repeated herein for conciseness, but instead the reader is referred to the above for more details.

The heater assembly 106 further comprises capillary tubes which are similar to capillary tubes 66 of FIG. 3. However, as can be seen in FIG. 4a, the first portion 62a of the substrate 62 comprises capillary tubes 166a (or portions thereof) having a first dimension dl (e.g. a width or diameter) and the second portion 62b of the substrate 62 comprises capillary tubes 166b (or portions thereof) having a second dimension d2 (e.g. a width or diameter). The first dimension d1 is different to the second dimension d2.

By way of example, we will consider the capillary tubes 166a, 166b to be cylindrical and therefore have circular cross-section when viewed along the longitudinal extent of the capillary tubes 166a, 166b. The circular cross-section therefore has a diameter which is either d1 for the capillary tubes 166a of the first portion 62a or d2 for the capillary tubes 166b of the second portion 62b. However, it should be understood that in other implementations the capillary tubes 166a, 166b may have other cross-sectional shapes, e.g., such as a square, oval, etc., in which case the characteristic dimension of extent of capillary tube 166a, 166b of the cross-sectional shape (e.g., the length or width) may correspond to the dimensions d1 and d2 respectively.

As can be seen in FIG. 4a, the capillary tubes 166b of the second portion 62b have a greater diameter d2 than the capillary tubes 166a of the first portion 62a. During normal use of the heater assembly 106, as per the discussion in association with FIG. 2, the heater assembly is orientated in the opposite way to how it is shown in FIG. 4a-that is, the second portion 62b faces towards the reservoir 46 while the first portion 62a faces towards the lower support unit 7. Generally, in normal use, gravity acts substantially in the direction from the second portion 62b towards the first portion 62a.

Hence, in normal use, liquid is permitted to flow along the capillary tubes 166b from the reservoir 46/wells 53 to the liquid aerosol-generating material storage region 62c. Providing relatively large diameter capillary tubes 166b in the second portion 62b permits a relatively greater volume/mass of liquid, as well as potentially greater flow rates of liquid, to flow from the reservoir 46 to the liquid aerosol-generating material storage region 62c. Accordingly, the liquid aerosol-generating material storage region 62c in such an implementation may be more readily and quickly replenished with liquid (for example, when the cartomizer 3 is returned to a normal orientation after the cartomizer has been inverted). Under the influence of gravity, liquid held in the liquid aerosol-generating material storage region 62c is able to flow to the capillary tubes 166a in first portion 62a, assuming that the liquid aerosol-generating material storage region 62c is suitably configured to allow the liquid to flow to the capillary tubes 166a in the first portion 62a (e.g., the surface tension within the liquid aerosol-generating material storage region 62c is not too great to prevent escape of the liquid).

When the cartomizer 3 is inverted, the heater assembly is orientated as shown in FIG. 4a, although the second portion 62b is therefore no longer directly in contact with the liquid in the reservoir 46/wells 53. In this scenario, gravity acts substantially in the direction from the first portion 62a towards the second portion 62b. In such an arrangement, it is assumed that some liquid is already held in the liquid aerosol-generating material storage region 62c. Some of this liquid, under the influence of gravity, may be directed towards the liquid reservoir 46 via the capillary tubes 166b. That is to say, some of the liquid may leak from the liquid aerosol-generating material storage region 62c of the heater assembly 6 through the second capillary tubes 166b.

However, in respect of the first capillary tubes 166a, liquid from the liquid aerosol-generating material storage region 62c is able to rise, under the capillary effect, along the length (or height) of the capillary tube 166a. Without wishing to be bound by theory, the capillary effect (i.e., the extent to which a liquid flows within a narrow space or tube) is dependent on several factors. For a given liquid interacting with a given surface/material, the height (h) of a column of liquid that rises in a tube of radius (r) above a bulk liquid level are approximately inversely proportional to one another. That is, h is proportional to 1/r. In the present example, the diameter of the capillary tubes 166a of the first portion 62a have a relatively smaller diameter, d1, and therefore one would expect the height (or distance along the capillary tube 166a that liquid is able to travel) to be much greater. Accordingly, by providing relatively narrow capillary tubes 166a in the first portion 62a of the substrate 62, liquid is capable of being supplied to the electrically resistive layer 64 even when the cartomizer 3/heater assembly 6 is inverted by virtue of the liquid aerosol-generating material storage region 62c and the relatively narrow capillary tubes 166a in the first portion 62a of the substrate 62. The properties of the liquid aerosol-generating material storage region 62c may be selected to help facilitate this liquid wicking to the electrically resistive layer 64. For example, the pore size of the liquid aerosol-generating material storage region 62c (e.g., the absorbent layer) may be set to be comparable or greater than the dimension d1.

Accordingly, by providing capillary tubes 166a, 166b having at least one different dimension, in particular the diameter (or more generally, a characteristic dimension of extent), in different portions 62a, 62b of the substrate 62, the performance of the heater assembly 6 in respect of liquid supply to the electrically resistive layer 64 can be modified. In particular, having capillary tubes 166b in the second portion 62b of a relatively greater diameter d2 allows for a more rapid wetting of the liquid aerosol-generating material storage region 62c, while having capillary tubes 166a in the first portion 62a of a relatively smaller diameter d1 allows for liquid to be supplied from the liquid aerosol-generating material storage region 62c to the electrically resistive layer 64 even when the heater assembly/cartomizer is inverted.

In respect of forming the capillary tubes 166a, 166b in the first and second portions respectively, the capillary tubes may be formed (e.g., laser drilled) into each portion separately. That is to say, the first portion 62a may have the capillary tubes 166a formed therein, while separately, the second portion 62b may have the capillary tubes 166b formed therein. Alternatively, the capillary tubes of a diameter d1 may be formed in the first and second portions simultaneously, while the capillary tubes of size d1 formed in the second portion 62b may then be increased in size through a separate forming process (e.g., laser drilling) to increase the diameter to d2.

FIG. 4b shows a second implementation of the heater assembly 206. Heater assembly 206 is broadly similar to heater assembly 6 described in FIG. 3, and in this regard the heater assembly 206 comprises a substrate 62 having a first portion 62a, second portion 62b and a liquid aerosol-generating material storage region 62c as described above, as well as an electrically resistive layer 64 again as described above. A description of these components is not repeated herein for conciseness, but instead the reader is referred to the above for more details.

The heater assembly 206 further comprises capillary tubes which are similar to capillary tubes 66 of FIG. 3. However, as can be seen in FIG. 4b, the first portion 62a of the substrate 62 comprises capillary tubes 266a (or portions thereof) having a first dimension d3 (e.g. a length or longitudinal extent) and the second portion 62b of the substrate 62 comprises capillary tubes 266b (or portions thereof) having a second dimension d4 (e.g. a length or longitudinal extent). The first dimension d3 is different to the second dimension d4.

As can be seen in FIG. 4b, the capillary tubes 266b of the second portion 62b have a greater length d4 than the capillary tubes 266a of the first portion 62a. That is to say, the capillary tubes 266a of the first portion 62a are relatively shorter than the capillary tubes 266b of the second portion 62b.

During normal use of the heater assembly 106, as per the discussion in association with FIG. 2, the heater assembly is orientated in the opposite way to how it is shown in FIG. 4b-that is, the second portion 62b faces towards the reservoir 46 while the first portion 62a faces towards the lower support unit 7. Generally, in normal use, gravity acts substantially in the direction from the second portion 62b towards the first portion 62a.

Hence, in normal use, liquid is permitted to flow along the capillary tubes 266b from the reservoir 46/wells 53 to the liquid aerosol-generating material storage region 62c. In this case, because the length, d3, of the capillary tubes 266b are relatively long, the uptake of liquid into the heater assembly (and in particular liquid aerosol-generating material storage region 62c) may be relatively slower (e.g., as compared to the example of FIG. 4a). However, it is expected that the heater assembly 6/cartomizer 3, in normal use, will spend the majority of its time in a normal orientation with the second portion 62b in direct contact with the liquid in the reservoir 46/wells 53 (as described above). As in FIG. 4a, under the influence of gravity, liquid held in the liquid aerosol-generating material storage region 62c is able to flow to the capillary tubes 266a in first portion 62a, assuming that the liquid aerosol-generating material storage region 62c is suitably configured to allow the liquid to flow to the capillary tubes 266a in the first portion 62a (e.g., the surface tension within the liquid aerosol-generating material storage region 62c is not too great to prevent escape of the liquid).

When the cartomizer 3 is inverted, the heater assembly is orientated as shown in FIG. 4b, although the second portion 62b is therefore no longer directly in contact with the liquid in the reservoir 46/wells 53. In this scenario, gravity acts substantially in the direction from the first portion 62a towards the second portion 62b. In such an arrangement, it is assumed that some liquid is already held in the liquid aerosol-generating material storage region 62c. Some of this liquid, under the influence of gravity, may be directed towards the liquid reservoir 46 via the capillary tubes 266b in the second portion 62b. That is to say, some of the liquid may leak from the liquid aerosol-generating material storage region 62c of the heater assembly 6 through the second capillary tubes 266b. However, owing to the fact that the capillary tubes 266b have a relatively long length d4, and in the case of FIG. 4b, the diameter of the capillary tubes 266b is comparable to the diameter of the capillary tubes 266a of the first portion 62a, the rate at which liquid leaks from the heater assembly 6 may be relatively slower than in the case of FIG. 4a.

In respect of the first capillary tubes 266a, liquid from the liquid aerosol-generating material storage region 62c is able to rise, under the capillary effect, along the length (or height) of the capillary tube 266a. As noted above, the height (h) of a column of liquid that rises in a tube of radius (r) above a bulk liquid level are approximately inversely proportional to one another. That is, h is proportional to 1/r. In the present example, the length d3 of the capillary tubes 266a of the first portion 62a are relatively shorter. This can mean that liquid can be more readily/quickly supplied to the electrically resistive layer 64. Additionally, depending on the configuration of the capillary tubes 266a in the first portion 62a, liquid may even be able to be supplied to the electrically resistive layer 64 as the liquid level in the liquid aerosol-generating material storage region 62c drops. That is, for a given diameter of capillary tubes 266a, if the height h is set to be greater than the length of the capillary tubes 266a, that is d3, then as the overall level of liquid in the liquid aerosol-generating material storage region 62c drops, liquid may still be able to be drawn up the capillary tubes 266a by virtue of capillary action.

Accordingly, by providing capillary tubes 266a, 266b having at least one different dimension, in particular the length (or more generally, a longitudinal extent), in different portions 62a, 62b of the substrate 62, the performance of the heater assembly 6 in respect of liquid supply to the electrically resistive layer 64 can be modified. In particular, having capillary tubes 266b in the second portion 62b of a relatively longer length d4 may help reduce the amount of liquid lost from the heater assembly 6 when the heater assembly is inverted, while having capillary tubes 266a in the first portion 62a of a relatively shorter length d3 may allow for liquid to be supplied from the liquid aerosol-generating material storage region 62c to the electrically resistive layer 64 even when the heater assembly/cartomizer is inverted.

While FIGS. 4a and 4b depict two implementations of the capillary tubes 166a, 166b, 266a, 266b in the respective portions 62a, 6b of the substrate 62 (and more particularly, two different dimensions of the capillary tubes respectively), it should be appreciated that in other implementations, the dimensions may be configured differently. For example, in respect of FIG. 4a, in some implementations the capillary tubes 166a of the first portion 62a may be set to have a greater diameter than the capillary tubes 166b of the second portion 62b. In respect of FIG. 4b, in some implementations, the capillary tubes 266a of the first portion 62a may be set to have a greater length than the capillary tubes 266b of the second portion 62b. In addition, it should be appreciated that in some implementations, combinations of the dimensions discussed in FIGS. 4a and 4b may be utilized. For example, in some implementations, the capillary tubes of the first portion 62a may be shorter and narrower than the capillary tubes of the second portion 62b.

Broadly speaking, in accordance with the principles of the present disclosure, at least one dimension (e.g., a diameter and/or length) of the one or more capillary tubes in the first portion 62a of the substrate 62 is different to a corresponding dimension (e.g., diameter and/or length) of the one or more capillary tubes in the second portion 62b of the substrate 62.

In respect of forming the capillary tubes 266a, 266b in the first and second portions respectively, the capillary tubes may be formed (e.g., laser drilled) into each portion separately. That is to say, the first portion 62a may have the capillary tubes 266a formed therein, while separately, the second portion 62b may have the capillary tubes 266b formed therein. Alternatively, the capillary tubes 266a, 266b may be formed in the first and second portions simultaneously.

In the examples of FIGS. 4a and 4b, the capillary tubes 166a, 166b, 266a, 266b do not extend through the liquid aerosol-generating material storage region 62c. That is to say, the liquid aerosol-generating material storage region 62c is positioned between, and interrupts, the common pathway between the capillary tubes of the respective portions 62a, 62b. However, it should be understood that in some implementations, the capillary tubes may extend through the liquid aerosol-generating material storage region 62c. For example, the liquid aerosol-generating material storage region 62c may be provided with tubes (e.g., formed by laser drilling or the like) that extend through the liquid aerosol-generating material storage region 62c from one side to the other and generally align with the capillary tubes of the first and second portions 62a, 62b. Accordingly, the capillary tubes (or portions thereof) 166a, 266a of the first portion 62a, the capillary tubes (or portions thereof) 166b, 266b of the second portion and the capillary tubes (or portions thereof) formed in the liquid aerosol-generating material storage region 62c are all coaxial and provided in fluid communication with one another. In respect of the implementation of FIG. 4a, the capillary tubes provided in the liquid aerosol-generating material storage region 62c may be formed to have a suitable diameter. The diameter may be the same as the capillary tubes 166a of the first portion 62a, e.g., dl, the same as the capillary tubes 166b of the second portion 62b, e.g., d2, or some variation therebetween—e.g., the capillary tube of the liquid aerosol-generating material storage region 62c may have a diameter between d1 and 2, or may be provided having a step between a part of the tube having a diameter d1 and a part of the tube d2 having a diameter d2, or even a tapered side walls of the tube tapering form a diameter d1 to a diameter d2.

In respect of forming the capillary tubes (or parts thereof) in the liquid aerosol-generating material storage region 62c, the capillary tubes may be formed (e.g., laser drilled) into the liquid aerosol-generating material storage region 62c separately from the forming of the capillary tubes in the first and second portions 62a, 62b. Alternatively, the capillary tubes of the liquid aerosol-generating material storage region 62c may be formed (e.g., laser drilled) simultaneously with the forming of the capillary tubes in the first and second portions 62a, 62b.

Additionally, FIGS. 4a and 4b show the capillary tubes 166a, 266a of the first portion 62a being coaxially aligned with the capillary tubes 166b, 266b of the second portion 62b. However, in other implementations, the capillary tubes in the first and second portions 62a, 62b are not coaxially aligned. By virtue of the presence of the liquid aerosol-generating material storage region 62c, which permits lateral/horizontal flow of the (held) liquid in the liquid aerosol-generating material storage region 62c, the capillary tubes in the first and second portions of the substrate 62 need not be provided in coaxial alignment with one another. For example, capillary tubes 166b, 266b in the second portion 62b may be provided only in regions that overlap with the wells 53 in the cartomizer 3 (for example, at either end of the central portion 67 in the longitudinal direction of the heater assembly 6 and/or at the end portions 68, 69 of the heater assembly).

In the examples described above, the liquid aerosol-generating material storage region 62c is provided as an absorbent material. However, in other implementations, the liquid aerosol-generating material storage region 62c may be provided as a cavity 362c within the substrate 62 configured to store/hold aerosol-generating material.

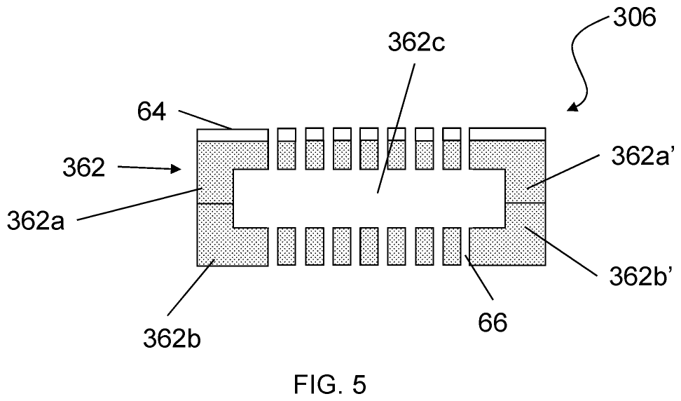

FIG. 5 schematically shows a heater assembly 306 according to a further implementation of the present disclosure. The heater assembly 306 is shown in cross-section and will be understood from FIGS. 4a and 4b. Heater assembly 306 is broadly similar to heater assembly 6 described in FIG. 3, and in this regard the heater assembly 306 comprises an electrically resistive layer 64 and capillary tubes 66 substantially as described above. A description of these components is not repeated herein for conciseness, but instead the reader is referred to the above for more details.

As seen in FIG. 5, the heater assembly 306 comprises a substrate 362 having a first portion 362a and a second portion 362b. The substrate 362 and first and second portions 362a, 362b are substantially the same as substrate 62 and first and second portions 62a, 62b described above in respect of FIG. 3. However, in the heater assembly 306 of FIG. 5, each of the first and second portions 362a, 362b comprise side walls 362a′, 362b′. The side walls 362a′, 362b′ are provided around the outer periphery of each of the first and second portions 362a, 362b respectively. More particularly, each of the first and second portions 362a, 362b can be considered to provide a surface which has a recessed portion in the central part thereof, with the side walls 362a′, 362b′ surrounding the recessed portion (as can be seen in FIG. 5). When the first and second portions 362a, 362b are joined/abutted together, the side walls 362a′, 362b′ and recessed portions act to form a cavity 362c, as the liquid aerosol-generating material storage region 62c, within the heater assembly 306. More particularly, the side walls 362a′, 362b′ are arranged to join/bond at the respective surfaces of the first and second portions 362a, 362b to thereby form an enclosed volume/cavity 362c therebetween which, aside from the capillary tubes 66, is not exposed to the environment outside the heater assembly 306 (this is in contrast to the heater assembly 6 of FIG. 3, where faces of the absorbent material are exposed). Additionally, it should be understood that compared to FIG. 3, it is the first and second portions 362a, 362b that are joined together, rather than each being joined to an intermediate component. Any suitable technique for fixing the first portion 362a to the second portion 362b may be employed (such as those described above).

The cavity 362c acts to hold or store liquid aerosol-generating material within the heater assembly 306. In this regard, the cavity 362c functions similarly to the absorbent material, in that the cavity 362c receives liquid from the capillary tubes 66 of the second portion 362b, supplies liquid to the capillary tubes 66 of the first portion 362a, and may permit the flow of liquid in a lateral/horizontal direction within the heater assembly 306.

When the heater assembly 306 is orientated in an orientation corresponding to normal use, e.g., as per the discussion in association with FIG. 2, the heater assembly 306 is orientated in the opposite way to how it is shown in FIG. 5—that is, the second portion 362b faces towards the reservoir 46 while the first portion 362a faces towards the lower support unit 7. Generally, in normal use, gravity acts substantially in the direction from the second portion 362b towards the first portion 362a. Hence, in normal use, liquid is permitted to flow along the capillary tubes 66 of the second portion 362b from the reservoir 46/wells 53 to the cavity 362c and, under the influence of gravity, then to the capillary tubes 66 in the first portion 362a.

When the cartomizer 3 is inverted, the heater assembly is orientated as shown in FIG. 5, although the second portion 362b is therefore no longer directly in contact with the liquid in the reservoir 46/wells 53. In this scenario, gravity acts substantially in the direction from the first portion 362a towards the second portion 362b. In such an arrangement, it is assumed that some liquid is already held in the cavity 362c. Some of this liquid, under the influence of gravity, may be directed towards the liquid reservoir 46 via the capillary tubes 66 in the second portion 362b. That is to say, some of the liquid may leak from the cavity 362c of the heater assembly 306. However, such leakage may be reduced or limited with appropriate choice of the size of the capillary tubes 66 in the second portion 362b and/or the cavity 362c. Additionally, some of the liquid held in the cavity 362c is supplied to the capillary tubes 66 of the first portion 362a. If the size (height) of the cavity 362c is sufficient to display a capillary effect (that is, if the height of the cavity 362 is small enough), then liquid may be retained to some degree within the cavity 362c when the heater assembly 306 is inverted. This liquid may be supplied to the capillary tubes 66 of the first portion 362a which may be provided in contact with the surface of the liquid held within the cavity 362c. Alternatively, if the size (height) of the cavity 362c is insufficient, such that the capillary tubes 66 of the first portion 362a are not generally in contact with the surface of the liquid in the cavity 362c when the heater assembly 306 is inverted, then the first portion 362a may include extensions of the capillary tubes 66 of the first portion 362a which protrude from the recessed portion of the first portion 362a into the cavity 362c. That is to say, the first portion 362a of the substrate 362 includes tubular sections that protrude from the surface of the first portion 362a and are coaxial with the capillary tubes 66 formed in the first portion 362a to thereby effectively change (e.g., lower) the position of the opening of the capillary tubes in the first portion with respect to the cavity 362c.

Accordingly, implementations of the heater assembly 306 in which a cavity 362c is used in place of an absorbent material as the liquid aerosol-generating material storage region 62c may be realised.

Moreover, while heater assembly 306 is shown with capillary tubes 66 described in conjunction with FIG. 3 of equal length/diameter in the first portion 362a and second portion 362b, it should be understood that the capillary tubes 66 may be formed having dimensions according to any of the implementations described in respect of FIGS. 4a and 4b, or more generally, that at least one dimension of the capillary tubes in the first portion 362a and the second portion 362b are different. It should be appreciated that FIG. 5 depicts an implementation of the heater assembly 306 which provides a cavity 362c. The cavity is formed by the side walls 362a′ and 362b′ of the first and second portions 362a, 362b respectively. While the cavity 362c is shown as an empty void in FIG. 5a, it should be appreciated that the cavity 362c may be filled with the absorbent material described above in conjunction with the liquid aerosol-generating material storage region 62c of FIGS. 3 to 4b. In other words, in some implementations, the absorbent material may be utilized with the first and second portions 362a, 362b having side walls 362a′, 362b′.

The examples of a cavity 362c and an absorbent material are provided as examples only, and any suitable medium which is capable of being positioned between the first and second portions of the substrate 62, 362, and configured to hold liquid, may be used in accordance with the principles of the present disclosure.

The heater assembly 6, 106, 206, 306 as described above is generally provided as a relatively small component having a relatively small footprint (as compared to more traditional heater assemblies, such as a wick and coil). However, owing in part to the fact the capillary tubes are formed via a manufacturing process in the heater assembly 6, 106, 206, 306 (i.e., the capillary tubes are engineered through a laser drilling process), the heater assembly 6, 106, 206, 306 can provide similar liquid delivery characteristics (and thus comparable aerosol formation characteristics) despite its relatively small size. That is to say, the heater assembly 6, 106, 206, 306 may provide more efficient wicking of liquid given that that diameter of the capillary tubes can be selected/optimised for a given liquid to be vaporized and that the capillary tubes are formed to follow substantially linear paths that directly deliver the liquid to the electrically resistive layer 64. By providing a smaller component, material wastage (e.g., when the cartomizer 3 is disposed of) can be reduced.

Not only can the liquid be provided more efficiently to the electrically resistive layer 64, but by manufacturing the capillary tubes, more control is given over the supply of liquid to the electrically resistive layer 64 (that is, the more capillary tubes of a certain diameter, the more liquid per unit time (ml/s) can be delivered to the electrically resistive layer 64).

Further, by including the liquid aerosol-generating material storage region 62c of the substrate 62, the feeding of liquid to the capillary tubes 66, 166, 266 can further be improved, as described above.

It should be appreciated that the configuration of the cartomizer 3 accommodating the heater assembly 6, 106, 206, 306 is provided as an example configuration of such a cartomizer 3. The principles of the present disclosure apply equally to other configurations of the cartomizer 3 (for example, comprising similar or different components to those as shown in FIGS. 1 and 2, and a similar or different layout to that shown in FIG. 2). That is, the cartomizer 3 and the relative position of the heater assembly 6, 106, 206, 306 in the cartomizer 3 is not significant to the principles of the present disclosure. Broadly speaking, a cartomizer is likely to comprise a top end (having the mouthpiece orifice 41) and a bottom end. In the examples shown above, the heater assembly 6, 106, 206, 306 is arranged to be below the reservoir 46, substantially horizontal to the longitudinal axis of the cartomizer 3, and arranged in an airflow path that is substantially perpendicular to longitudinal axis of the heater assembly. However, this need not be case, and in other implementations the cartomizer 3 may be configured differently depending on the particular design and application at hand.

For example, the heater assembly 6, 106, 206, 306 may be arranged such that airflow is substantially parallel to the longitudinal axis of the heater assembly, e.g., along the exposed surface of the electrically resistive layer 64. For example, the upper clamping unit 5 may not be provided with the central air passage 58 and instead the air passage may be provided to one side of the upper clamping unit 5. Air may enter the cartomizer 3 by a suitable inlet and flow along the longitudinal surface of the heater assembly 6, 106, 206, 306 (and along the electrically resistive layer 64) before passing in a substantially vertical direction through the air passage 58 positioned at one end of the upper clamping unit 5 (e.g., the end opposite the air inlet). The outer housing 4 and mouthpiece orifice 41 may be suitably configured. In such an example, the wells 53 of the upper clamping unit 5 may supply the entire central portion 67 of the heater assembly 6 with liquid aerosol-generating material from the reservoir. In the example shown in FIG. 2, the contact pads 75 directly contact the electrically resistive layer 64 of the heater assembly 6, 106, 206, 306. However, the cartomizer 3 may be provided with any suitable arrangement that facilitates the electrical contact between the aerosol provision device 2 and the heater assembly 6, 106, 206, 306. For example, in some implementations, electrical wiring or other electrically conductive elements may extend between the electrically resistive layer 64 and the contact pads 75 of the cartomizer 3. This may particularly be the case when the heater assembly 6, 106, 206, 306 has its largest dimension (e.g., its length) less than a minimum distance between the contact pads 75. The distance between the contact pads 75 may be dictated by the electrical contacts on the aerosol provision device 2.

It should also be appreciated that while the above has described a cartomizer 3 which includes the heater assembly 6, 106, 206, 306, in some implementations the heater assembly 6, 106, 206, 306 may be provided in the aerosol provision device 2 itself. For example, the aerosol provision device 2 may comprise the heater assembly 6 and a removable cartridge (containing a reservoir of liquid aerosol-generating material). The heater assembly 6, 106, 206, 306 is provided in fluid contact with the liquid in the cartridge (e.g., via a suitable wicking element or via another fluid transport mechanism). Alternatively, the aerosol provision device 2 may include an integrated liquid storage area in addition to the heater assembly 6, 106, 206, 306 which may be refillable with liquid. More broadly, the aerosol provision system (which encompasses a separable aerosol provision device and cartomizer/cartridge or an integrated aerosol provision device and cartridge) includes the heater assembly.

Additionally, the above has described a heater assembly 6, 106, 206, 306 in which an electrically resistive layer 64 is provided on a surface of the respective substrate. In the aerosol provision system 1 of FIG. 2, electrical power is supplied to the electrically resistive layer 64 via the contact pads 75. Accordingly, an electrical current is able to flow through the electrically resistive layer 64 from one end to the other to cause heating of the electrically resistive layer 64. However, it should be understood that electrical power for the purposes of causing the electrically resistive layer 64 to heat may be provided via an alternative means, and in particular, via induction. In such implementations, the aerosol provision system 1 is provided with a coil (known as a drive coil) to which an alternating electrical current is applied. This subsequently generates an alternating magnetic field. When the electrically resistive layer 64 is exposed to the alternating magnetic field (and it is of sufficient strength), the alternating magnetic field causes electrical current (Eddy currents) to be generated in the electrically resistive layer 64. These currents can cause Joule heating of the electrically resistive layer 64 owing to the electrical resistance of this layer 64. Depending on the material which the electrically resistive layer 64 is formed, heating may additionally be generated through magnetic hysteresis (if the material is ferro-or ferrimagnetic). More generally, the electrically resistive layer 64 is an example of a heater layer of the heater assembly 6, 106, 206, 306 which is configured to generate heat when supplied with energy (e.g., electrical energy), which, for example, may be provided through direct contact or via induction. Additional ways of causing the heater layer to generate heat are also considered within the principles of the present disclosure.

Moreover, it should be understood that in some implementations, an additional layer or layers, e.g., serving as a protective layer, may be disposed on top of the electrically resistive layer 64. In such implementations, the capillary tubes 66, 166, 266 still extend to an opening on the electrically resistive layer 64 but may additionally extend through the additional layer(s). More broadly, the capillary tubes 66, 166, 266 extend through the heater assembly 6, 106, 206, 306 to an opening at a surface of a side of the heater assembly 6, 106, 206, 306 comprising the electrically resistive layer 64, which includes an opening in the electrically resistive layer 64 itself as well as an opening in any additional layer(s) positioned above the electrically resistive layer 64.

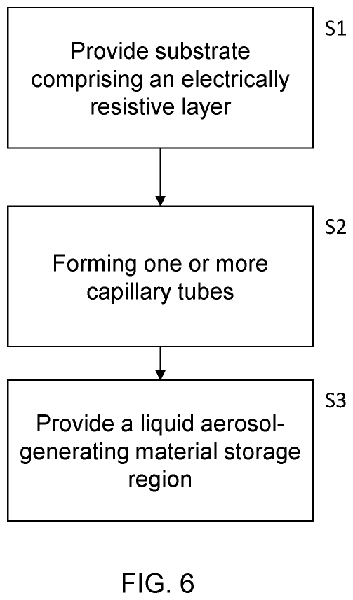

FIG. 6 depicts an example method for manufacturing the heater assemblies 6, 106, 206, 306.

The method begins at step S1 by providing a substrate 62, 362 comprising an electrically resistive layer 64 provided on a first surface of the substrate. The way in which the substrate 62, 362 is formed is not significant to the principles of the present disclosure. For example, the substrate 62, 362 may be cut from a portion of cultured quartz or formed via a sintering process by sintering quartz powders/fibers, for example. The first portion 62a, 362a of the substrate 62, 362 may be formed separately from the second portion 62b, 362b, as discussed above.

The way in which the electrically resistive layer 64 is formed on the surface of the substrate 62, 362 (and more particularly on the surface of the first portion 62a, 362a of the substrate 62, 362) is not significant to the principles of the present disclosure. For example, the electrically resistive layer 64 may be a sheet of metal (e.g., titanium) adhered, welded, or the like to the substrate 62, 362. Alternatively, the electrically resistive layer 64 may be formed through a vapor or chemical deposition technique using the substrate 62, 362 as a base. Yet a further alternative is to grow or culture the substrate 62, 362 using the electrically resistive layer 64 as a base.

Once the substrate 62, 362 including an electrically resistive layer 64 is provided, the method proceeds to step S2 where one or more capillary tubes 66, 166, 266 are formed in the substrate 62, 362/electrically resistive layer 64. As noted above, the capillary tubes 66, 166, 266 extend from a surface (another surface) of the substrate 62, 362 through the electrically resistive layer 64 provided on the first surface of the substrate 62, 362. That is, as shown in FIGS. 4a to 5, the capillary tubes 66, 166, 266 extend all the way through the heater assembly 6, 106, 206, 306. The capillary tubes 66, 166, 266 may be formed by laser drilling, as noted above, or any other suitable technique. Furthermore, as described above, the capillary tubes 66, 166, 266 may be formed in the first and second portions 62a, 62b, 362a, 362b of the substrate 62, 362 separately or simultaneously.

The method proceeds to step S3. At step S3, a liquid aerosol-generating material storage region 62c, 362c located between the first portion 62a, 362a and the second portion 62b, 362b of the substrate 62, 362 is provided. As described above, the liquid aerosol-generating material storage region 62c, 362c may comprise an absorbent material and/or a cavity.

Although step S3 is shown as proceeding step S2, it should be understood that depending upon the implementation at hand, method step S3 may be provided at a different location within the method. For example, for the implementation shown in FIG. 3, step S3 may be provided after step S2 such that by assembling the first and second portions 62a, 62b having capillary tubes drilled therein along with the absorbent material, the absorbent material is provided to the heater assembly 6. Equally, in the implementation of FIG. 5, assembling the first and second portions 362a, 362b having preformed capillary tubes therein additionally provides the liquid aerosol-generating material storage region 362c. For implementations where capillary tubes are additionally provided in the absorbent material, the absorbent material may be provided with step S1 and subsequently capillary tubes may be formed therein in step S2 along with the capillary channels of the first and second portions 62a, 62bAdditionally, in some implementations, capillary tubes may be formed in the substrate 62 prior to providing the electrically resistive layer 64 (e.g., via a deposition technique). In such implementations, step S2 and optionally step S3 may precede step S1, noting that the provision of a substrate 62 is required for step S2 and optionally step S3 to be performed. Thus, it should be understood that the method of FIG. 6 is an example method only, and adaptations to the steps or ordering of the steps of this method are contemplated within this disclosure.

Thereafter, once the heater assembly 6, 106, 206, 306 is formed, the heater assembly 6, 106, 206, 306 may be positioned in a cartomizer 3 or more generally an aerosol provision system 1.

Thus, there has been described a heater assembly for an aerosol provision system, the heater assembly including a substrate; a heater layer configured to generate heat when supplied with energy, the heater layer provided on a first surface of the substrate; and one or more capillary tubes extending from another surface of the substrate through the heater layer provided on the first surface of the substrate. The substrate comprises a first portion and a second portion, the first portion comprising the first surface of the substrate, wherein at least one dimension of the one or more capillary tubes in the first portion of the substrate is different to a corresponding dimension of the one or more capillary tubes in the second portion of the substrate, and wherein the substrate additionally comprises a liquid aerosol-generating material storage region located between the first portion and the second portion of the substrate. Also described is a cartomizer including the heater assembly, an aerosol provision system including the heater assembly, and a method for manufacturing the heater assembly.

While the above described embodiments have in some respects focused on some specific example aerosol provision systems, it will be appreciated the same principles can be applied for aerosol provision systems using other technologies. That is to say, the specific manner in which various aspects of the aerosol provision system function are not directly relevant to the principles underlying the examples described herein.

In order to address various issues and advance the art, this disclosure shows by way of illustration various embodiments in which the claimed invention(s) may be practiced. The advantages and features of the disclosure are of a representative sample of embodiments only, and are not exhaustive and/or exclusive. They are presented only to assist in understanding and to teach the claimed invention(s). It is to be understood that advantages, embodiments, examples, functions, features, structures, and/or other aspects of the disclosure are not to be considered limitations on the disclosure as defined by the claims or limitations on equivalents to the claims, and that other embodiments may be utilized and modifications may be made without departing from the scope of the claims. Various embodiments may suitably comprise, consist of, or consist essentially of, various combinations of the disclosed elements, components, features, parts, steps, means, etc. other than those specifically described herein, and it will thus be appreciated that features of the dependent claims may be combined with features of the independent claims in combinations other than those explicitly set out in the claims. The disclosure may include other inventions not presently claimed, but which may be claimed in future.

1. A heater assembly for an aerosol provision system, the heater assembly comprising:
a substrate;
a heater layer configured to generate heat when supplied with energy, the heater layer provided on a first surface of the substrate; and
one or more capillary tubes extending from another surface of the substrate through the heater layer provided on the first surface of the substrate,
wherein the substrate comprises a first portion and a second portion, the first portion comprising the first surface of the substrate, wherein at least one dimension of the one or more capillary tubes in the first portion of the substrate is different to a corresponding dimension of the one or more capillary tubes in the second portion of the substrate, and wherein the substrate additionally comprises a liquid aerosol-generating material storage region located between the first portion and the second portion of the substrate.

2. The heater assembly of claim 1, wherein the one or more capillary tubes in the first portion of the substrate are configured so as to transport liquid aerosol-generating material from the liquid aerosol-generating material storage region to the heater layer.

3. The heater assembly of claim 1, wherein the first portion of the substrate comprises one or more capillary tubes having a first cross-sectional area in a direction of extent of the one or more capillary tubes, and the second portion of the substrate comprises one or more capillary tubes having a second cross-sectional area in a direction of extent of the one or more capillary tubes, the second cross-sectional area being different to the first cross-sectional area.

4. The heater assembly of claim 3, wherein the first cross-sectional area is smaller than the second cross-sectional area.

5. The heater assembly of claim 1, wherein the first portion of the substrate comprises one or more capillary tubes having a first longitudinal extent, and the second portion of the substrate comprises one or more capillary tubes having a second longitudinal extent, the second longitudinal extent being different to the first longitudinal extent.

6. The heater assembly of claim 5, wherein the first longitudinal extent is shorter than the second cross-sectional area.

7. The heater assembly of claim 1, wherein the liquid aerosol-generating material storage region comprises an absorbent material for holding liquid aerosol-generating material.

8. The heater assembly of claim 1, wherein the liquid aerosol-generating material storage region comprises a cavity formed between at least a part of the first portion and the second portion, the cavity sized so as to hold liquid aerosol-generating material therein.

9. The heater assembly of claim 1, wherein the first portion and the second portion are separately formed components configured so as to be able to be joined or fixed together.

10. The heater assembly of claim 1, wherein the first portion of the substrate is formed from a first material and the second portion is formed from a second material.

11. The heater assembly of claim 10, wherein the first and second materials are the same material.

12. The heater assembly of claim 1, wherein the substrate is formed from quartz.

13. The heater assembly of claim 1, wherein the one or more capillary tubes have a diameter in the range of 10 to 250 μm.

14. The heater assembly of claim 1, wherein the one or more capillary tubes are formed by laser drilling.

15. A cartomizer for use with an aerosol-generating device for generating aerosol from an aerosol-generating material, the cartomizer comprising:
a reservoir for storing aerosol-generating material, and
a heater assembly according to claim 1, wherein the heater assembly is provided in fluid communication with the reservoir.

16. An aerosol provision system for generating aerosol from an aerosol-generating material, the aerosol provision system comprising the heater assembly of claim 1.

17. An aerosol provision system comprising an aerosol provision device and a cartomizer for use with the aerosol provision device for generating aerosol from an aerosol-generating material, the cartomizer comprising:
a reservoir for storing aerosol-generating material, and
a heater assembly according to claim 1, wherein the heater assembly is provided in fluid communication with the reservoir,
wherein the cartomizer is releasably connectable to the aerosol provision device.

18. A method of manufacturing a heater assembly for an aerosol provision system, the method comprising:
providing a substrate comprising a heater layer configured to generate heat when supplied with energy, the heater layer provided on a first surface of the substrate, wherein the substrate comprises a first portion and a second portion, the first portion comprising the first surface of the substrate;
forming one or more capillary tubes extending from another surface of the substrate through the heater layer provided on the first surface of the substrate, wherein at least one dimension of the one or more capillary tubes in the first portion of the substrate is different to a corresponding dimension of the one or more capillary tubes in the second portion of the substrate; and
providing a liquid aerosol-generating material storage region located between the first portion and the second portion of the substrate.

19. Heater means for an aerosol provision system, the heater means comprising:
a substrate;
heater layer means configured to generate heat when supplied with energy, the heater layer means provided on a first surface of the substrate; and
capillary means extending from another surface of the substrate through the heater layer provided on the first surface of the substrate,
wherein the substrate comprises a first portion and a second portion, the first portion comprising the first surface of the substrate, wherein at least one dimension of the capillary means in the first portion of the substrate is different to a corresponding dimension of the capillary means in the second portion of the substrate, wherein the substrate additionally comprises a liquid aerosol-generating material storage means located between the first portion and the second portion of the substrate.
